(19) United States
(12) Patent Application Publication
(10) Pub. No.: US 2022/0109616 A1
(43) Pub. Date: Apr. 7, 2022

(54) MULTI ACCESS POINT-CLOUD CONTROLLER FOR COLLECTING NETWORK STATISTICAL DATA

(71) Applicant: ARRIS Enterprises LLC, Suwanee, GA (US)

(72) Inventor: Krishna Prasad Panje, Bengaluru (IN)

(21) Appl. No.: 17/484,487

(22) Filed: Sep. 24, 2021

Related U.S. Application Data
(60) Provisional application No. 63/086,764, filed on Oct. 2, 2020.

(51) Int. Cl. H04L 12/26

(52) U.S. Cl. CPC H04L 43/065; H04L 43/16; H04L 43/0882; H04L 43/067

(57) ABSTRACT

A cloud controller for requesting statistical data about a network when at least one network device is unable to respond to the request. The cloud controller sends a command to network devices requesting statistical data be gathered. The cloud controller determines that a network device experiences a problem with obtaining the requested statistical data and identifies a network device as an efficient network device. The cloud controller configures the efficient network device to obtain the requested statistical data from other network devices in the network. The cloud controller determines that the problem with the network device has been resolved, and begins communicating with the network device having the problem resolved to request statistical data concerning the network.

### BACKGROUND

The subject matter of the present disclosure relates generally to efficiently gathering network statistical data when at least one access point is unable to gather and return such statistical data.

Network device may be used to gather statistical data from a home network. The efficiency of gathering statistical data depends on the reporting capability of a weakest device in the home network. An AP that experiences problems gathering statistical data may cause the user to experience degraded Quality of Experience (QoE), such as with steering of network devices among APs in a network. For example, an AP may experience momentary issues or may have developed hardware faults. Such problems may be caused by bandwidth limitations, resource limitations, and client load issues. These issues might make the network device respond slower to a request for gathering of statistical data from a cloud controller.

### SUMMARY

An aspect of the present disclosure involves using a cloud controller to collect statistical data about a network.

A cloud controller sends a command to network devices in a network to provide requested statistical data identified in the command. The cloud controller determines that at least one of the network devices experiences a problem with obtaining the requested statistical data concerning the network and identifies one of the network devices as an efficient network device. The problem experienced by the at least one network device comprises at least one of a bandwidth limitation, a resource limitation, a high client load, and a slow response time for receiving the requested statistical data concerning the network.

The cloud controller configures the efficient network device to obtain the requested statistical data from other network devices in the network. The cloud controller identifies the efficient network device as needed to obtain the requested statistical data concerning the network within a predetermined time period. The cloud controller requests that the efficient network device cache the statistical data for the cloud controller. The cloud controller maintains at least one connection to the network, wherein the at least one connection includes a connection with the efficient network device. The cloud controller determines that the problem with the at least one of the network devices has been resolved, and begins communicating with the at least one of the network devices having the problem resolved to request statistical data concerning the network.

### BRIEF SUMMARY OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a schematic diagram of a system implementing the network device.

FIG. 2 illustrates a network device.

FIG. 3 is a diagram of a cloud controller.

FIG. 4 is a flow chart that illustrates using a cloud controller to collect statistical data about a network.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness.

Aspects of the present disclosure are directed to using a cloud controller to collect statistical data about a network.

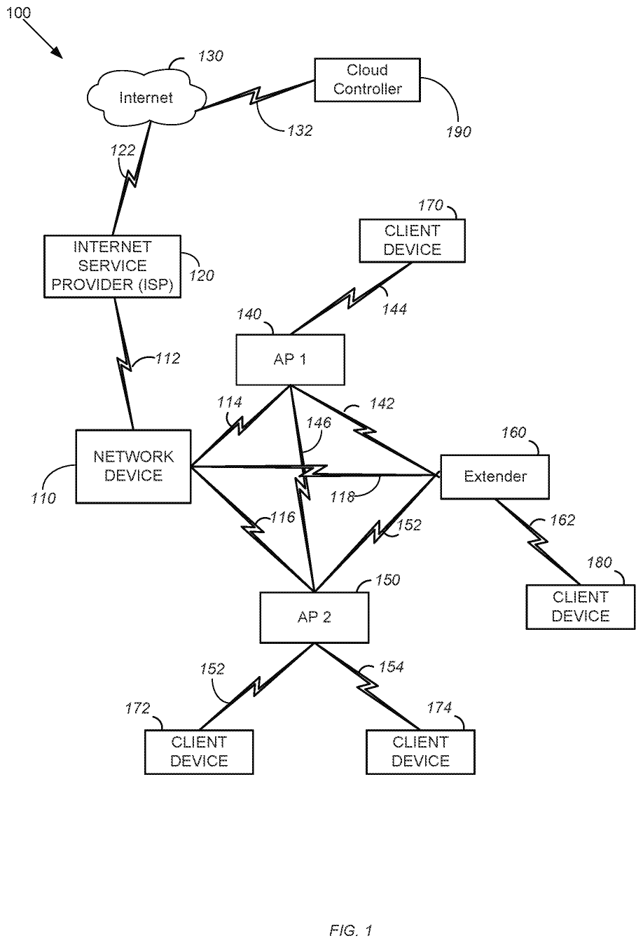

FIG. 1 is a schematic diagram of a system implementing the network device.

As shown in FIG. 1, the main elements of the system include a Network Device 110 connected to an Internet Service Provider (ISP) 120 via connection 112. ISP 120 is connected to the Internet 130 via connection 122. Cloud Controller 190 is connected to Internet 130 via connection 132. Alternatively, Cloud Controller 190 may be located at the ISP 120, or anywhere outside the network. Further, Cloud Controller 190 may be a distributed system or may be at least partially configured at Network Device 110.

Network Device 110 is connected to different wireless devices, such as Access Point (AP 1) 140 via connection 114, Access Point (AP 2) 150 via connection 116. Extender 160 is coupled to Access Point 140 via connection 142 and to Access Point 150 via connection 152. Access Point 140 is connected to Access Point 150 via connection 146. Network Device 110 is connected to Extender 160 via connection 118.

Client Device 170 is connected to Access Point 140 via connection 144 while Client Devices 172, 174 are connected to Access Point 150 via connections 152, 154, respectively. Client Device 180 is initially connected to Extender 160 via connection 162. However, Client Device 180 device 180 may roam within the network and establishes a connection with Access Point 140 or Access Point 150. It should be understood that Client Devices 172, 174 may also roam and establish connections with Extender 160 or Access Point 140. Similarly, Client Device 170 may roam and establish a connection with Extender 160 or Access Point 150.

Client Devices 170, 172, 174, 180, and Extender 160, as shown in FIG. 1, may be connected in one or more wireless networks in system 100 (e.g., private, guest, iControl, backhaul network, or Internet of things (IoT) network). Additionally, there could be some overlap between wireless devices (e.g., wireless devices 170, 172, 174, 180, and Extender 160) in the different networks. That is, one or more network devices could be located in more than one network. For example, Extender 160 could be located both in a private network for providing content and information to Client Device 180 via connection 162 and also may be included in a backhaul network or an iControl network.

The ISP 120 can be, for example, a streaming video provider or any computer for connecting the Network Device 110 to the Internet 130. The connection 122 between the Internet 130 and the ISP 120 and the connection 112 between the ISP 120 and the Network Device 110 can be implemented using a wide area network (WAN), a virtual private network (VPN), metropolitan area networks (MANs), system area networks (SANs), a DOCSIS network, a fiber optics network (e.g., FTTH (fiber to the home) or FTTX (fiber to the x), or hybrid fiber-coaxial (HFC)), a digital subscriber line (DSL) a public switched data network (PSDN), a global Telex network, or a 2G, 3G, 4G or 5G network, for example.

Connection 112 can further include as some portion thereof a broadband mobile phone network connection, an optical network connection, or other similar connections. For example, connection 112 can also be implemented using a fixed wireless connection that operates in accordance with, but is not limited to, 3rd Generation Partnership Project (3GPP) Long Term Evolution (LTE) or 5G protocols. It is also contemplated by the present disclosure that connection 112 is capable of providing connections between the Network Device 110 and a WAN, a LAN, a VPN, MANs, PANs, WLANs, SANs, a DOCSIS network, a fiber optics network (e.g., FTTH, FTTX, or HFC), a PSDN, a global Telex network, or a 2G, 3G, 4G or 5G network, for example.

The Network Device 110 can be, for example, a hardware electronic device that may be a combination modem and gateway device that combines the functions of a modem, an access point, and/or a router for providing content received from the content provider (ISP) 120 to network devices (e.g., Client Devices 170, 172, 174, 180, and Extender 160 in the system 100. It is also contemplated by the present disclosure that the Network Device 110 can include the function of, but is not limited to, an Internet Protocol/Quadrature Amplitude Modulator (IP/QAM) set-top box (STB) or smart media device (SMD) that is capable of decoding audio/video content, and playing over-the-top (OTT) or multiple system operator (MSO) provided content.

Connection 114 between Network Device 110 and Access Point 140, connection 116 between Network Device 110 and Access Point 150, and connections 142, 152 between Extender 160 and Access Point 140 and Access Point 150, respectively, and connection 146 between Access Point 140 and Access Point 150 can be implemented using a wireless connection in accordance with any IEEE 802.11 Wi-Fi protocols, Bluetooth protocols, Bluetooth Low Energy (BLE), or other short range protocols that operate in accordance with a wireless technology standard for exchanging data over short distances using any licensed or unlicensed band such as the citizens broadband radio service (CBRS) band, 2.4 GHz bands, 5 GHz bands, 6 GHz bands, 60 GHz bands, etc. Additionally, connections 114, 116, 142, 146, 152 can be implemented using a wireless connection that operates in accordance with, but is not limited to, RF4CE protocol, ZigBee protocol, Z-Wave protocol, or IEEE 802.15.4 protocol. It is also contemplated by the present disclosure that the connections 114, 116, 142, 146, 152 can include connections to a media over coax (MoCA) network. One or more of the connections 114, 116, 142, 146, 152 can also be a wired Ethernet connection.

Extender 160 can be, for example, hardware electronic devices such as Access Points used to extend the wireless network by receiving the signals transmitted by the Access Point 140, for example, and rebroadcasting the signals to, for example, Client Device 180, which may out of range of the Access Point 140. Extender 160 can also receive signals from the Client Device 180 and rebroadcast the signals to the Access Point 140, or Access Point 150.

Connections 144, 152, 154, 162 are implemented through a wireless connection that operates in accordance with any IEEE 802.11 Wi-Fi protocols, Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands, 60 GHz bands, etc. Additionally, the connections 144, 152, 154, 162 can be implemented using a wireless connection that operates in accordance with, but is not limited to, RF4CE protocol, ZigBee protocol, Z-Wave protocol, or IEEE 802.15.4 protocol. Also, connections 144, 152, 154, 162 can be a wired Ethernet connection. Client Devices 170, 172, 174, 180 can be, for example, hand-held computing devices, personal computers, electronic tablets, smart phones, smart speakers, IoT devices, iControl devices, portable music players with smart capabilities capable of connecting to the Internet, cellular networks, and interconnecting with other devices via Wi-Fi and Bluetooth, or other wireless hand-held consumer electronic devices capable of executing and displaying content received through the Network Device 110.

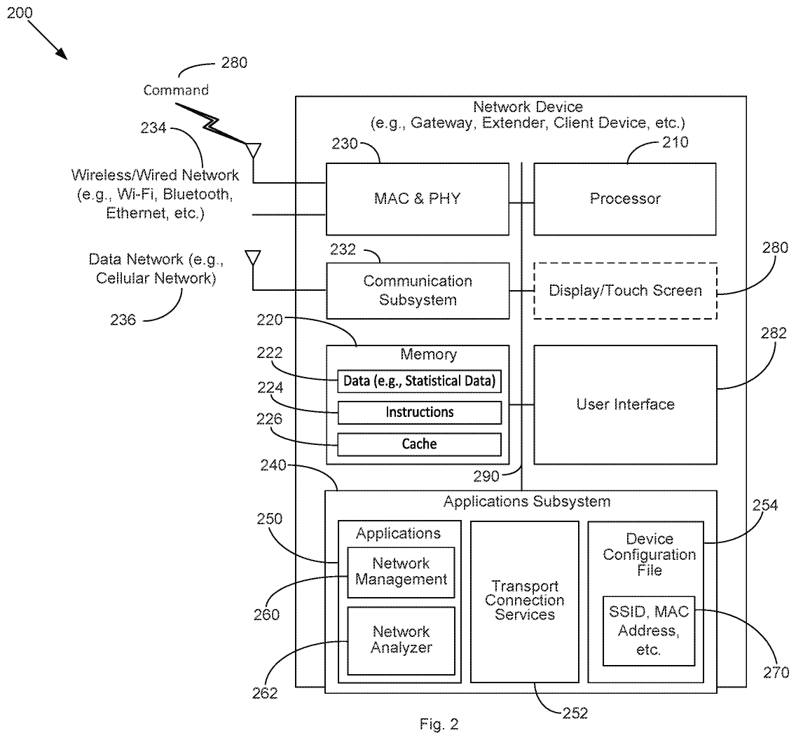

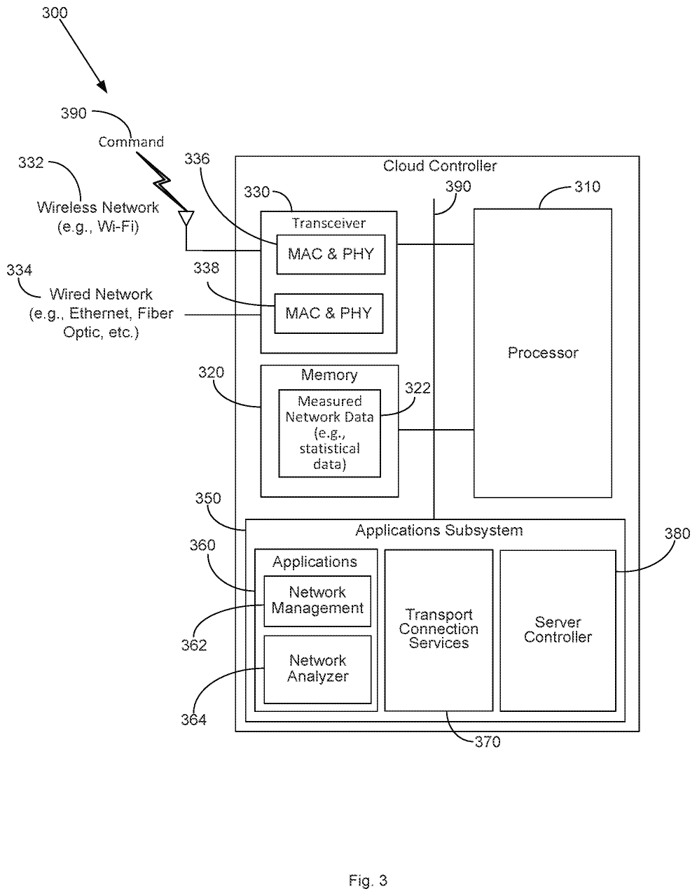

A detailed description of the exemplary internal components of the Network Device 110, Access Point 140, Access Point 150, Extender 160, and Client Devices 170, 172, 174, 180, as shown in in FIG. 1, will be provided in the discussion of FIGS. 2-3. However, in general, it is contemplated by the present disclosure that the Network Device 110, Access Point 140, Access Point 150, Extender 160, and Client Devices 170, 172, 174, 180, as shown in in FIG. 1, include electronic components or electronic computing devices operable to receive, transmit, process, store, and/or manage data and information associated with the system, which encompasses any suitable processing device adapted to perform computing tasks consistent with the execution of computer-readable instructions stored in a memory or a computer-readable recording medium.

Further, any, all, or some of the computing components in the Network Device 110, Access Point 140, Access Point 150, Extender 160, and Client Devices 170, 172, 174, 180, as shown in in FIG. 1, may be adapted to execute any operating system, including Linux, UNIX, Windows, MacOS, DOS, and ChromOS as well as virtual machines adapted to virtualize execution of a particular operating system, including customized and proprietary operating systems. The Network Device 110, Access Point 140, Access Point 150, Extender 160, and Client Devices 170, 172, 174, 180, as shown in in FIG. 1, are further equipped with components to facilitate communication with other computing devices over the one or more network connections to local and wide area networks, wireless and wired networks, public and private networks, and any other communication network enabling communication in the system.

Cloud Controller 190 includes a processor configured to execute computer-readable instructions maintained in memory to send a command to network devices in a network to provide requested statistical data identified in the command. Cloud Controller 190 determines that at least one of the network devices experiences a problem with obtaining the requested statistical data concerning the network and identifies one of the network devices as an efficient network device. The problem experienced by the at least one network device comprises at least one of a bandwidth limitation, a resource limitation, a high client load, and a slow response time for receiving the requested statistical data concerning the network.

Cloud Controller 190 configures the efficient network device to obtain the requested statistical data from other network devices in the network. Cloud Controller 190 identifies the efficient network device as needed to obtain the requested statistical data concerning the network within a predetermined time period. Cloud Controller 190 requests that the efficient network device cache the statistical data for the Cloud Controller 190. Cloud Controller 190 maintains at least one connection to the network, wherein the at least one connection includes a connection with the efficient network device. Cloud Controller 190 determines that the problem with the at least one of the network devices has been resolved, and begins communicating with the at least one of the network devices having the problem resolved to request statistical data concerning the network.

FIG. 2 illustrates a network device 200.

In FIG. 2, the network device 200 may be a gateway, an extender, client devices, etc. Network device 200 may include a processor 210, memory 220, a media access controller (MAC) and physical transceiver (PHY) 230, communications system 232, and applications subsystem 240. Media access controller (MAC) and physical transceiver (PHY) 230 provides wireless and wired communication with an IP network, such as a Wi-Fi network.

Communication subsystem 232 provides communication with a data network 236, such as a cellular network. Network device 200 may also include a display/touch screen 280 and a user interface 282. Not all network devices 200 include display/touch screen 280. However, some network devices 200 may allow control, management, or configuration through a web browser via user interface 282 instead of display/touch screen 280.

Memory 220 includes data 22 including statistical data provided by a client device. Application subsystem 240 includes applications 250, transport connection services 252 and a device configuration file 254. Applications 250 may include network management 260 and a network analyzer 262. Device configuration file 254 may include, among other information, a service set identifier (SSID) and a MAC address 270, as well as other identifiers.

Processor 210 may be configured to execute instructions 224 stored on said memory 220 to cause said network device 200 to, for example, wireless/wired network communication 234 (such as Wi-Fi, Bluetooth, Ethernet, etc.) via Media access controller (MAC) and physical transceiver (PHY) 230 and communications via data network 236 using communication subsystem 232. Processor 210 may execute the processes carried out by the network management 260, network analyzer 262, and transport connection services 252. Processor 210 may further implement the device configuration file 254 and cause data 222 provided by client devices to be stored by memory 220. Communication between the components (e.g., 210, 220, 230, 232, 240, 280, 282) of the network device 200 may be established using an internal bus 290.

Certain subject matter of the present disclosure is described herein as including logic or a number of components, units, elements, or mechanisms. The network device 200 may constitute either software elements (e.g., code embodied on a machine-readable medium) or hardware elements. A “hardware element” is a tangible unit capable of performing certain operations and may be configured or arranged in a certain physical manner. In various example, one or more computer systems (e.g., a standalone computer system, a client computer system, or a server computer system) or one or more hardware elements of a computer system (e.g., a processor or a group of processors) may be configured by software (e.g., an application or application portion) as a hardware element that operates to perform certain operations as described herein.

Processor 210 may be configured to execute computer-readable instructions maintained in memory 220 to send a command 280, for example via wireless/wired network communication 234, to network devices in a network to provide requested statistical data identified in the command 280. Processor 210 uses network analyzer 262 to determine that at least one of the network devices experiences a problem with obtaining the requested statistical data concerning the network and identifies one of the network devices as an efficient network device. The problem experienced by the at least one network device comprises at least one of a bandwidth limitation, a resource limitation, a high client load, and a slow response time for receiving the requested statistical data concerning the network.

Processor 210 configures, as needed, the efficient network device to obtain the requested statistical data from other network devices in the network. Processor 210 identifies the efficient network device to obtain the requested statistical data concerning the network within a predetermined time period. Processor 210 requests that the data 222, such as the statistical data obtained by efficient network device, be maintained in cache 226 until sent to a cloud controller. Processor 210 maintains at least one connection to the network, wherein the at least one connection includes a connection with the efficient network device. Processor 210 determines that the problem with the at least one of the network devices has been resolved, and begins communicating with the at least one of the network devices having the problem resolved to request statistical data concerning the network.

FIG. 3 is a diagram of a cloud controller 300.

In FIG. 3, the cloud controller 300 includes a processor 310, memory 320, a transceiver 330 with medium access control (MAC) and physical layer (PHY) circuits 336, 338, and applications subsystem 350. Memory 320 includes measured network data 322 that has been collected by network devices.

Applications subsystem 350 includes applications 360, transport connection services 370, and a server controller 380. MAC/PHY 336 supports wireless Wi-Fi connections using 2.4 GHz bands, 5 GHz bands, 6 GHz bands, 60 GHz bands, etc. MAC/PHY 336 implements physical layer functions to provide physical access for signals communicated over a wireless link, and controls transmission/receipt of data packets to and from wireless network 332. MAC/PHY 338 may support wired connections 334, such as Ethernet. MAC/PHY 338 implements physical layer functions to provide physical access for signals communicated over wired networks 334. Communication between the components (e.g., 310, 320, 330, 350) of the cloud controller 300 may be established using an internal bus 390.

Transport connection services 370 provide reliable communication between processes and involve the establishment of connections between the cloud controller 300 and a network device. Server controller 380 provides control and management of server operations for collecting statistical data from the network device, analysis of the statistical data, provides reports based on the statistical data, and sends commands to network device to optimize connections of network devices, and to optimize the load of APs. Applications 360 include a network manager 362 to provide networking configuration and setup information to server controller 380 so that the network can operate efficiently and a network analyzer 364 to monitor and troubleshoot the network.

Processor 310 may be configured to send a command 390, for example via wireless/wired network communication 332, to network devices in a network to request statistical data. Processor 310 may use network analyzer 364 to determine that at least one of the network devices experiences a problem with obtaining the requested statistical data concerning the network and identifies one of the network devices as an efficient network device. This may also be delegated to a network device, such as a gateway, AP, or extender as described with reference to FIG. 2. Processor 310 may determine that the problem experienced by the at least one network device comprises at least one of a bandwidth limitation, a resource limitation, a high client load, and a slow response time for receiving the requested statistical data concerning the network.

Processor 310 controls configuration of the efficient network device, as needed, to obtain the requested statistical data from other network devices in the network. Processor 310 may identify the efficient network device within a predetermined time period. Processor 310 requests that the data 322, such as the statistical data obtained by efficient network device, be maintained in cache of the efficient network device until the data 322 is sent to the cloud controller 300. Processor 310 may use the network analyzer 364 to determine that the problem with the at least one of the network devices has been resolved, and that communication may begin with the network devices having the problem resolved to request statistical data concerning the network. Processor 310 may determine another problem with a network device occurs and whether to repeat identification of an efficient network device.

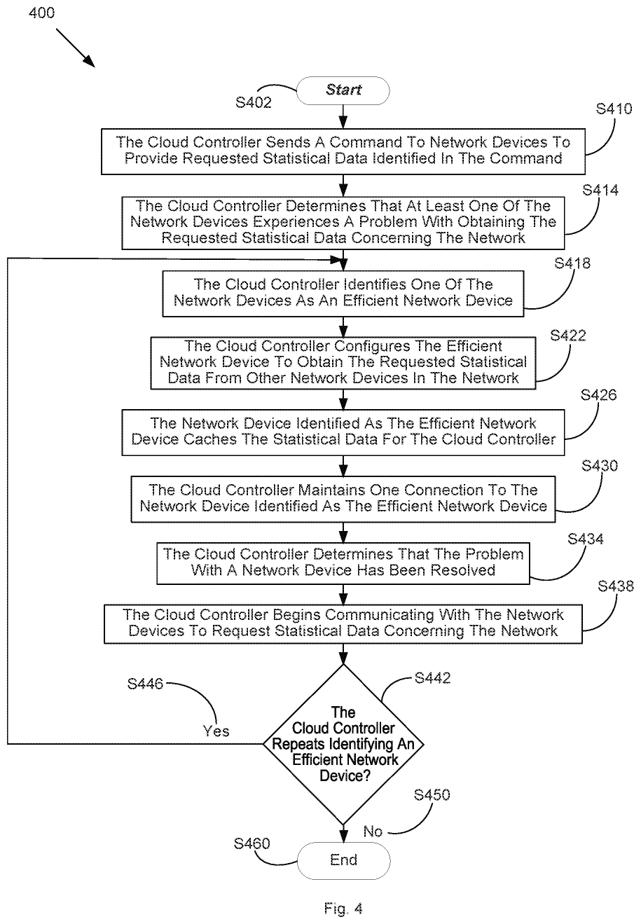

FIG. 4 is a flow chart 400 that illustrates using a cloud controller to collect statistical data about a network.

In FIG. 4, it is assumed that the network device includes software stored in memory, which when executed perform functions and operations of the subject matter of the present disclosure. In FIG. 4, method 400 starts (S402), and the cloud controller sends a command to network devices to provide requested statistical data identified in the command (S410). Referring to FIG. 3, processor 310 may be configured to send a command 390, for example via wireless/wired network communication 332, to network devices in a network to request statistical data.

The cloud controller determines at least one of the network devices experiences a problem with obtaining the requested statistical data concerning the network (S414). Referring to FIG. 3, processor 310 may use network analyzer 364 to determine that at least one of the network devices experiences a problem with obtaining the requested statistical data concerning the network. This may also be delegated to a network device, such as a gateway, AP, or extender as described with reference to FIG. 2. Processor 310 may determine that the problem experienced by the at least one network device comprises at least one of a bandwidth limitation, a resource limitation, a high client load, and a slow response time for receiving the requested statistical data concerning the network.

The cloud controller identifies one of the network devices as an efficient network device (S418). Referring to FIG. 3, processor 310 may identify one of the network devices as an efficient network device. Processor 310 may identify the efficient network device within a predetermined time period.

The cloud controller configures the efficient network device to obtain the requested statistical data from other network devices in the network (S422). Referring again to FIG. 3, processor 310 controls configuration of the efficient network device, as needed, to obtain the requested statistical data from other network devices in the network.

The network device identified as the efficient network device caches the statistical data for the cloud controller (S426). Processor 310 requests that the data 322, such as the statistical data obtained by efficient network device, be maintained in cache of the efficient network device until the data 322 is sent to the cloud controller 300.

The cloud controller maintains one connection to the network device identified as the efficient network device (S430). The cloud controller determines the problem with a network device has been resolved (S434). Referring to FIG. 3, processor 310 may use the network analyzer 364 to determine that the problem with the at least one of the network devices has been resolved.

The cloud controller begins communicating with the network devices to request statistical data concerning the network (S438). Referring to FIG. 3, processor 310 determines that communication may begin with the network devices having the problem resolved to request statistical data concerning the network.

The cloud controller determines whether identification of an efficient network device is to be repeated (S442). Referring again to FIG. 3, processor 310 may determine another problem with a network device occurs and whether to repeat identification of an efficient network device. If yes (S446), the process loops back to identify one of the network devices as an efficient network device (S418). If no (S450), method 400 then ends (S460).

The processes discussed in this disclosure may be implemented in hardware, software, or a combination thereof. In the context of software, the described operations represent computer-executable instructions stored on one or more non-transitory computer readable recording medium that, when executed by one or more hardware processors, perform the recited operations. Generally, computer-executable instructions include routines, programs, objects, components, data structures, and the like that perform particular functions or implement particular abstract data types. Those having ordinary skill in the art will readily recognize that certain steps or operations illustrated in the figures above may be eliminated, combined, or performed in an alternate order. Any steps or operations may be performed serially or in parallel. Furthermore, the order in which the operations are described is not intended to be construed as a limitation.

Subject matter of the present disclosure may be provided as a computer program product including one or more non-transitory computer readable recording medium having stored thereon instructions (in compressed or uncompressed form) that may be used to program a computer (or other electronic device) to perform processes or methods described herein. The computer-readable storage media may include one or more of an electronic storage medium, a magnetic storage medium, an optical storage medium, a quantum storage medium, or the like. For example, the computer-readable storage media may include, but are not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. Further, subject matter of the present disclosure may also be provided as a computer program product including a transitory machine-readable signal (in compressed or uncompressed form). Examples of machine-readable signals, whether modulated using a carrier or unmodulated, include, but are not limited to, signals that a computer system or machine hosting or running a computer program may be configured to access, including signals transferred by one or more networks. For example, a transitory machine-readable signal may comprise transmission of software by the Internet. Separate instances of these programs can be executed on or distributed across any number of separate computer systems. Thus, although certain steps have been described as being performed by certain devices, software programs, processes, or entities, this need not be the case. A variety of alternative implementations will be understood by those having ordinary skill in the art.

Use of the phrases “capable of,” “capable to,” “operable to,” or “configured to”, refers to some apparatus, logic, hardware, and/or element designed in such a way to enable use of the apparatus, logic, hardware, and/or element in a specified manner. The subject matter of the present disclosure is provided as examples of apparatus, systems, methods, and programs for performing the features described in the present disclosure. However, further features or variations are contemplated in addition to the features described above. It is contemplated that the implementation of the components and functions of the present disclosure can be done with any newly arising technology that may replace any of the above implemented technologies.

Additionally, those having ordinary skill in the art readily recognize that the techniques described above can be utilized in a variety of devices, environments, and situations. Although the subject matter has been described in language specific to structural features or methodological acts, it is to be understood that the subject matter defined in the appended claims is not necessarily limited to the specific features or acts described. Rather, the specific features and acts are disclosed as exemplary forms of implementing the claims.

What is claimed is:

1. A cloud controller, comprising:
a memory storing computer-readable instructions; and
a processor configured to execute the computer-readable instructions to:
send a command to network devices in a network to provide requested statistical data identified in the command;
determine that at least one of the network devices experiences a problem with obtaining the requested statistical data concerning the network;
identify one of the network devices as an efficient network device; and
configure the efficient network device to obtain the requested statistical data from other network devices in the network.

2. The cloud controller of claim 1, wherein the processor repeats identifying one of the network devices as the efficient network device as needed to obtain the requested statistical data concerning the network within a predetermined time period.

3. The cloud controller of claim 1, wherein the problem experienced by the at least one network device comprises one of a bandwidth limitation, a resource limitation, and a high client load.

4. The cloud controller of claim 1, wherein the problem comprises a slow response time for receiving the requested statistical data concerning the network.

5. The cloud controller of claim 1, wherein the processor requests that the efficient network device cache the statistical data for the cloud controller.

6. The cloud controller of claim 1, wherein the processor maintains one connection to the network, wherein the one connection is with the efficient network device.

7. The cloud controller of claim 1, wherein the processor determines that the problem with the at least one of the network devices has been resolved, begins communicating with the at least one of the network devices having the problem resolved to request statistical data concerning the network.

8. A method for collecting statistical data concerning a network, comprising:
sending a command from a cloud controller to network devices in the network to provide requested statistical data identified in the command;
determining, by the cloud controller, that at least one of the network devices experiences a problem with obtaining the requested statistical data concerning the network;
identifying, by the cloud controller, one of the network devices as an efficient network device; and
configuring, by the cloud controller, the efficient network device to obtain the requested statistical data from other network devices in the network.

9. The method of claim 8 further comprising repeating the identifying one of the network devices as the efficient network device as needed to obtain the requested statistical data concerning the network within a predetermined time period.

10. The method of claim 8, wherein the determining that the at least one of the network devices experiencing the problem with obtaining the requested statistical data concerning the network further comprises determining that the problem experienced by the at least one network device includes one of a bandwidth limitation, a resource limitation, and a high client load.

11. The method of claim 8, wherein the determining that the at least one of the network devices experiencing the problem with obtaining the requested statistical data concerning the network further comprises determining that the problem experienced by the at least one network device includes a slow response time for receiving the requested statistical data concerning the network.

12. The method of claim 8 further comprising caching the statistical data concerning the network at the efficient network device for the cloud controller.

13. The method of claim 8 further comprises maintaining one connection to the network by the cloud controller, wherein the one connection is with the efficient network device.

14. The method of claim 8 further comprises determining that the problem with the at least one of the network devices has been resolved, and beginning to communicate with the at least one of the network devices having the problem resolved to request statistical data concerning the network.

15. A non-transitory computer-readable media having computer-readable instructions stored thereon, which when executed by a processor causes the processor to perform operations comprising:
sending a command from a cloud controller to network devices in a network to provide requested statistical data identified in the command;
determining, by the cloud controller, that at least one of the network devices experiences a problem with obtaining the requested statistical data concerning the network;
identifying, by the cloud controller, one of the network devices as an efficient network device; and
configuring, by the cloud controller, the efficient network device to obtain the requested statistical data from other network devices in the network.

16. The non-transitory computer-readable media of claim 15 further comprising repeating the identifying one of the network devices as the efficient network device as needed to obtain timely statistical data concerning the network.

17. The non-transitory computer-readable media of claim 15, wherein the determining that the at least one of the network devices experiencing the problem with obtaining the requested statistical data concerning the network further comprises determining that the problem experienced by the at least one network device includes one of a bandwidth limitation, a resource limitation, and a high client load.

18. The non-transitory computer-readable media of claim 15, wherein the determining that the at least one of the network devices experiencing the problem with obtaining the requested statistical data concerning the network further comprises determining that the problem experienced by the at least one network device includes a slow response time for receiving the requested statistical data concerning the network.

19. The non-transitory computer-readable media of claim 15 further comprises caching the statistical data concerning the network at the efficient network device for the cloud controller and maintaining one connection to the network by the cloud controller, wherein the one connection is with the efficient network device.

20. The non-transitory computer-readable media of claim 15 further comprises determining that the problem with the at least one of the network devices has been resolved, and beginning to communicate with the at least one of the network devices having the problem resolved to request statistical data concerning the network.
